(19) United States
(12) Patent Application Publication
(10) Pub. No.: US 2026/0300376 A1
(43) Pub. Date: Oct. 1, 2026

(54) SYSTEM AND METHOD FOR DETERMINING A PROTECTIVE ELEMENT

(71) Applicant: Hilti Aktiengesellschaft, Schaan (LI)

(72) Inventors: Ozak Esu, Buchs (CH); Luke Derek Moores, Bath (GB); Ioannis Petousis, Lachen SZ (CH)

(73) Assignee: Hilti Aktiengesellschaft, Schaan (LI)

(21) Appl. No.: 19/489,109

(22) PCT Filed: Jun. 13, 2024
(86) PCT No.: PCT/EP2024/066334

§ 371 Date: Dec. 1, 2025

(30) Foreign Application Priority Data
Jun. 28, 2023 (EP) 23182064.8

(51) Int. Cl. G06F 16/435

(52) U.S. Cl. CPC G06F 16/435

(57) ABSTRACT

The invention relates to a system (30) for determining a protective element (12) of a protective element type for use in an application situation (14) which relates to a construction component (10). It comprises an input device (37), an output device (40) and a database (25), wherein the database (25) comprises a multiplicity of comparative datasets (26) which comprise data relating to each comparative application situation (27), wherein the system (30) is configured to receive via the input device (37) an input dataset (36) which comprises data relating to the application situation (14) and, depending on the input dataset (36), to output via the output device (40) at least one of the comparative datasets (26), a part of at least one of the comparative datasets (26), a reference to at least one of the comparative datasets (26) and/or at least one identifier (42) of a protective element (12) of the protective element type. Construction components (10) can therefore be equipped with suitable protective elements (12) in a particularly economic but nevertheless reliable manner. Furthermore, the invention also relates to a method (100).

The invention relates to a system for determining a protective element of a protective element type for use in an application situation which relates to a construction component.

In order to protect construction components with regard to different risks, for example the risk of fire, different protective elements, for example fire protection elements, are available. The protective elements are respectively usable for specific application situations and in particular certified for these.

However, during the planning of construction components, application situations can result which do not correspond directly to these specific application situations and for which no protective element directly certified for this purpose is thus available. Therefore, in order to ensure adequate protection for such an application situation, complicated individual analyses are necessary. These can frequently be very time-consuming. The results, and therefore the safety and service life of the construction components, can thus depend considerably on the design and experience and also on the ability to concentrate of those who create these individual analyses.

It is therefore an object of the present invention to offer a system and a method which permit reliable protection of construction components. Particularly preferred are systems and methods which also permit particularly economic protection of the construction components.

The object is achieved firstly by a system for determining a protective element of a protective element type for use in an application situation which relates to a construction component, comprising an input device, an output device and a database, wherein the database comprises a large number of comparative datasets which comprise data relating to each comparative application situation, wherein the system is configured to receive via the input device an input dataset which comprises data relating to the application situation and, depending on the input dataset, to output via the output device at least one of the comparative datasets, a part of at least one of the comparative datasets, a reference to at least one of the comparative datasets and/or at least one identifier of a protective element of the protective element type.

The input dataset comprises data of the application situation. The system can thus make it possible to assign and/or output one or more comparative datasets by using the input dataset. Even if no identical comparative dataset and therefore no protective element that is directly certified for the application situation is available for the application situation represented by the input dataset, a protective element or its identifier that is suitable for this application situation can be determined by using the one comparative dataset or the multiple comparative datasets.

The system can also be configured to immediately output an identifier relating to one or more suitable protective elements.

By using the system, a large multiplicity of comparative datasets can be evaluated economically, reproducibly and with an assured quality. The construction component can then be equipped with the protective elements determined in such a way, so that the construction component can reliably be protected by the suitable protective element. As a result of the economic determination of the protective element, this reliable protection can also be obtained particularly economically. Incorrect equipping of construction components with unsuitable protective elements on the basis of lack of design or experience or over-fatigue or the like is avoided.

The construction component can comprise a part or the entire structure of a civil engineering or underground structure, a steel structure such as an oil drilling platform or the like. The construction component can be or comprise, for example, a wall, a ceiling and/or a floor of the structure.

The comparative datasets can also comprise one or more results of the system from earlier determinations of comparative datasets and/or suitable protective elements for earlier application situations.

The comparative datasets can be selected in such a way that they meet specific minimum quality requirements. For example, they can be restricted to results from earlier individual analyses of specific experts who, for example, meet specific training requirements and/or have specific minimum experience.

The comparative datasets can preferably relate to application situations for which protective elements of the desired protective element type are available and/or certified. If such a comparative dataset can thus be assigned to the input dataset, a suitable protective element can be derived directly from the comparative dataset. For this purpose, the database can comprise at least one respective identifier of an associated protective element of the protective element type for at least one, preferably all, of the comparative datasets.

The system can be configured to assign one or more comparable comparative datasets to the input dataset and/or to output the same on the output device. The comparative datasets and/or identifiers of protective elements connected thereto can then be output on the output device.

If no comparable comparative dataset is found, the system can also be configured to assign no result or an error signal which signals that no comparable comparative dataset is available and/or to output the same on the output device.

During the planning of construction components, very different types of application situations can result. To describe these many and varied application situations, in particular image data, for example in the form of CAD drawings, photographs, sketches or the like can be available and/or created. Such image data can depict application situations in a very detailed and precise manner. For example, by means of image data, geometric relationships can be described simply and precisely. It is therefore beneficial if the input dataset and/or at least one of the comparative datasets comprises image data.

The system can then preferably be configured to process image data of the input dataset and/or one or more comparative datasets. For this purpose, the system can have an image processing unit and/or an image and speech processing unit, for example in the form of a vision-language model.

Frequently, certifications of protective elements are carried out for specific categorical properties of the application situations, for example for specific material types, for specific locations such as, for example, mounting in a wall, on a ceiling or the like, for specific levels of protection, for example for specific resistance classes or the like. To this end, provision can be made for the input dataset and/or at least one of the comparative datasets to comprise nominal-scaled data. The system can be configured to process such nominal-scaled data from the input dataset and/or at least one of the comparative datasets. Nominal-scaled data also offers the advantage that, by using it, the input dataset and/or the comparative datasets can be categorized directly. The input dataset can thus be compared very simply and quickly with one or more of the comparative datasets, at least in relation to properties with nominal-scaled data.

In order to permit the greatest possible flexibility of the system, provision can also be made for the input dataset and/or at least one of the comparative datasets to comprise text data. Accordingly, the system can be configured to process such free-text data. For this purpose, the system can have a module for processing natural speech, an NLP, natural language processing, module below.

For the selection and/or classification of comparative datasets, the system can be configured to determine a subset of the comparative datasets as a function of the input dataset. It can in particular comprise a classifier. It can be configured to output more than one comparative dataset and/or more than one identifier. This makes it possible to output a plurality of equivalent comparative datasets and/or a plurality of equivalent identifiers with regard to the application situation.

The system can have at least one mapping matrix for the 1:n assignment of property values of an application situation. Preferably n can be n>=2. The mapping matrix can thus be configured in such a way that one or more property values are assigned to a property value. For example, with regard to a specific protective element type, for example in the area of fire protection elements, the material of a substrate may be relevant only to a limited extent for the selection of a suitable protective element. For example, it could be that a fire protection sealing compound which is certified for use on concrete is also suitable for use on sheetrock but not for use on wood. Then, the mapping matrix could have an assignment of the material property value “sheetrock” to “sheetrock” and “concrete”, i.e have a 1:2 assignment. It could also have only the assignment of the material property value “wood” to “wood”, i.e. a 1:1 assignment, and so on.

With the aid of such a mapping matrix, suitable comparative datasets can be pre-selected very efficiently for individual properties of the application situations.

The system can also have a plurality of mapping matrices, in particular for more than one property of the application situations. By means of sequential filtering by using the various mapping matrices, a particularly comprehensive pre-selection can thus already be carried out.

The mapping matrices can be obtained with the aid of expert estimations.

The system can have a machine learning system. In particular, the system can have a machine learning system and/or be a machine learning system. The machine learning system can have, for example, a neural network, a support vector machine, a deep learning unit or the like. The machine learning system can be trained by using manually prepared expert estimations relating to application situations and suitable protective elements, for example the protective elements certified for the respective application situations. It is conceivable that the system, in particular the machine learning system, is configured to receive feedback and, particularly preferably, to update the machine learning system, in particular to re-train it, with the aid of the feedback.

The system can thus be configured overall to filter one or more of the comparative datasets by using a similarity thereof to the input dataset.

In the event of too low a similarity, in particular when a limiting value of a distance between the input dataset representing the application situation and one or more, in particular each, of the comparative datasets is exceeded, the system can be configured to output no comparative dataset, no reference to at least one of the comparative datasets and no identifier.

In this case, for example, an error signal can be output. The error signal can correspond to the fact that no sufficiently similar comparative dataset could be found.

The protective element type can be fire protection elements, insulation elements, that is to say elements for protecting against energy loss and/or energy input, in particular against heat loss and/or cold loss, acoustic protection elements and/or moisture protection elements.

In particular in the case of fire protection, specific application situations which cannot be covered by standard approval methods often result. The system is then also particularly advantageous in particular when the protective element type relates to fire protection elements, since the effect of missing or incorrect fire protection measures can be particularly catastrophic in the event of fire.

Furthermore, a method for determining a protective element of a protective element type for use in an application situation which relates to a construction component falls within the scope of the invention, wherein, by using a system of the type described previously and/or below, an input dataset which comprises data relating to an application situation is compared with a plurality of comparative datasets which each comprise comparative application situations and at least one respective associated protective element of the protective element type, and wherein, as a result of the comparison, at least one of the comparative datasets, a part of at least one of the comparative datasets, a reference to at least one of the comparative datasets and/or an identifier of a protective element of the protective element type is determined. In an analogous argument to that described above for the system, the method thus also permits particularly economic and reliable protection of construction components, in particular entire structures.

Further features and advantages of the invention will be apparent from the detailed description of exemplary embodiments of the invention that follows, with reference to the figures of the drawing, which shows details essential to the invention, and from the claims. The features shown therein should not necessarily be considered to be true to scale and are illustrated in such a manner that the special features according to the invention can be clearly visualized. The various features can be implemented individually in their own right or collectively in any combinations in variants of the invention.

Exemplary embodiments of the invention are illustrated in the schematic drawing and will be explained in detail in the following description.

In the figures:

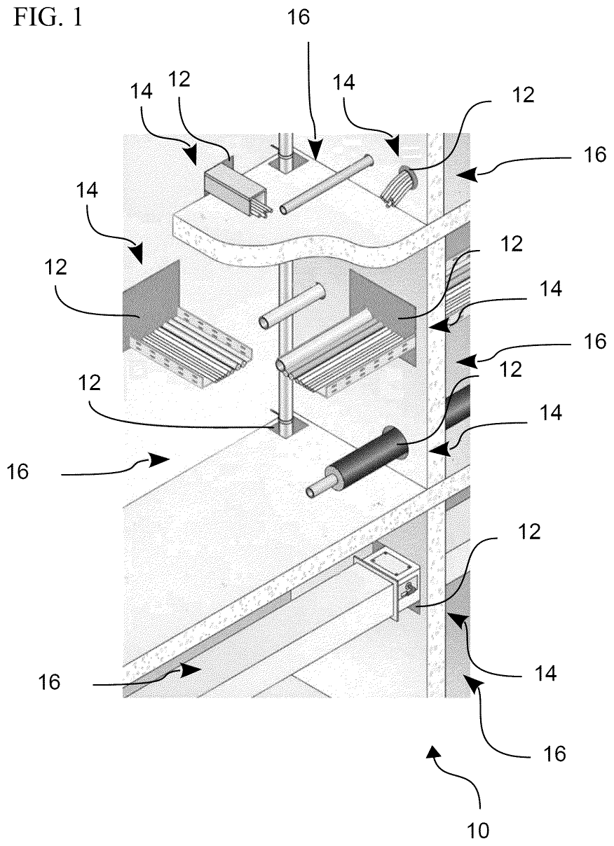

FIG. 1 shows a construction component with different protective elements,

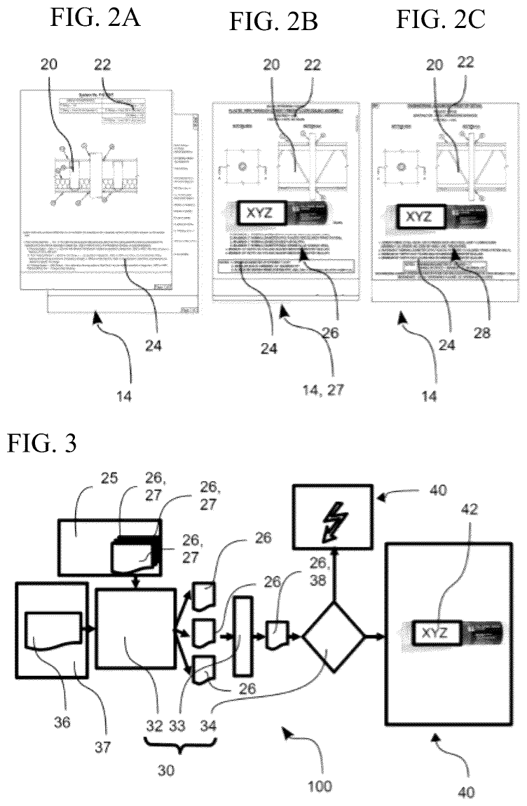

FIGS. 2a-c show schematic illustrations of an application situation, a comparative dataset and a resultant dataset,

FIG. 3 shows a schematic for a method for determining a protective element of a protective element type for a construction component,

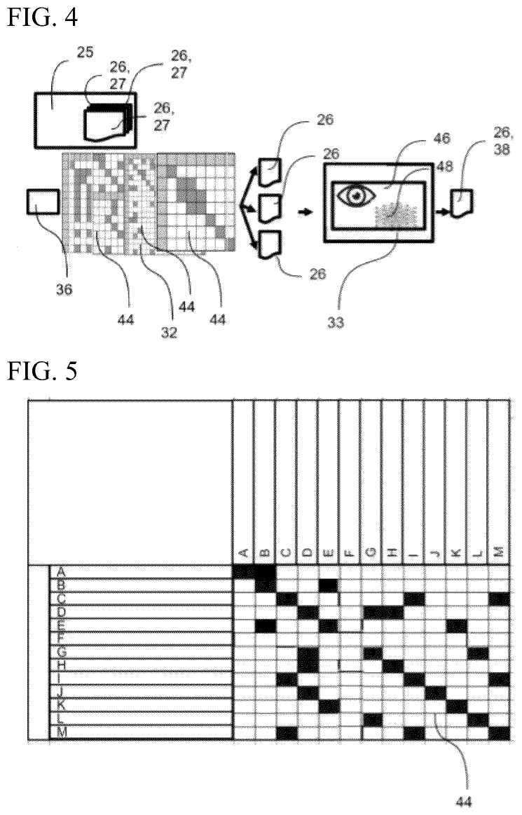

FIG. 4 shows a system having a plurality of system parts for determining a protective element,

FIG. 5 shows a similarity matrix,

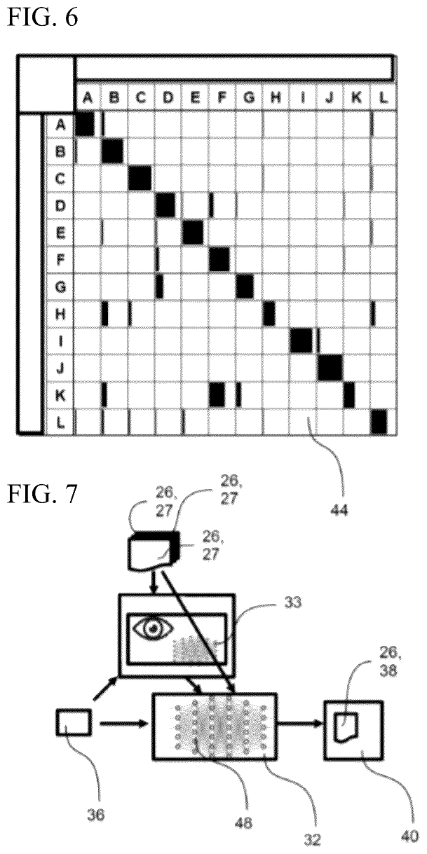

FIG. 6 shows a further similarity matrix, and

FIG. 7 shows alternative system parts for determining a protective element.

In the description of the figures that follows, comprehension of the invention is facilitated by use of the same reference signs in each case for identical or functionally corresponding elements.

The exemplary embodiments described below relate to fire protection measures. Thus, the following explanations relate to protective elements which are designed as fire safety protective elements. This is to be understood as merely exemplary; it is conceivable to use the systems and methods shown also for other protective element types, for example one or more of the aforementioned protective element types.

FIG. 1 shows a construction component 10 in a schematic, perspective, partly sectioned view, in particular a detail of a building, having a multiplicity of protective elements 12 in different application situations 14. The protective elements 12 are designed as fire protection elements. In particular, they are configured to prevent propagation of fire from one room 16 into another room 16 or vice versa or at least to make it more difficult, depending on the protection class. The application situations 14 can differ, for example, with regard to the type of substrate material, in the case of wall apertures with regard to the dimensions and/or the shapes of the wall apertures, of the elements leading through the wall apertures, for example supply lines or power lines, with regard to the required flexibility, that is to say whether and to what extent changes to the protective element 12 are subsequently necessary or possible, with regard to required fire safety protection classes to be achieved and/or the like.

In order to ensure optimal fire protection, the protective elements 12 for such application situations 14 are to be selected in accordance with the respective certifications of the protective elements 12 and to be installed properly. In cases in which an application situation 14 corresponds to none of the application situations for which protective elements 12 are available, in particular certified, a most comparable application system for which a protective element 12 is available should as far as possible be determined.

FIGS. 2a, 2b and 2c show schematic illustrations of application situations 14. In the examples illustrated, these illustrations comprise image data 20, nominal-scaled data 22 and structured, semi-structured and/or unstructured text data 24. The text data 24 can also be at least nominal-scaled.

Amongst other things, the image data represents geometric peculiarities of the application situations 14.

The nominal-scaled data 22 relates, for example, to designations of materials or protection classes to be reached. In addition to true nominal-scaled data, it can also comprise more highly scaled data, in particular ordinal-scaled data.

The text data 24 comprises supplementary information relating to the application situations 14, for example with regard to the layer structure of the floor, a ceiling or a wall illustrated in the image data 20. It is also possible for further dimensional statements, references to norms and standards to be complied with or the like to be included.

To this end, FIG. 2a shows an example of an application situation 14 from a list of standard application situations.

FIG. 2b shows an example of an application situation 14 for which a protective element 12 in the form of a fire protection element is certified. In the example illustrated, this is a fire-inhibiting sealing paste put into a tube, for sealing gaps between a wall or a floor and a pipe to be led through the wall or the floor.

The application situation 14, together with the associated protective element 12 which is certified for the application situation 14, can form a comparative dataset 26 for a system described in more detail below. Here and in the following text, application situations 14 of comparative datasets 26 are also designated as comparative application situations 27.

FIG. 2c shows an example of a possible resultant dataset 28 which, for example, can be obtained by the system still to be described. In the embodiment illustrated, the resultant dataset 28 likewise comprises an application situation 14 and an associated protective element 12, determined as described in more detail below.

In the examples according to FIGS. 2b and 2c, the comparative dataset 26 and the resultant dataset 28 largely correspond, for example the respective image data 20 coincide but there are differences with regard to the text data 24.

FIG. 3 shows a method 100 for determining a protective element 12 (see FIG. 1) of a protective element type, in the present example in particular a fire protection element, for use in an application situation 14 (see, for example, FIG. 2a) which relates to a construction component 10 (see FIG. 1), wherein by using a system 30, which, in this exemplary embodiment, comprises a first, a second and a third system part 32, 33 and 34, an input dataset 36 which comprises data relating to the application situation 14 is compared with a multiplicity of comparative datasets 26 stored in a database 25 which each comprise data relating to comparative application situations 27 and respectively at least one associated protective element 12 of the protective element type, and wherein, as a result of the comparison, at least one of the comparative datasets 26, at least a part of one of the comparative datasets 26, a reference to at least one of the comparative datasets 26 and/or an identifier of a protective element 12 of the protective element type is determined.

Thus, in this exemplary embodiment the system 30 is built up from many parts. Accordingly, there is provision in the exemplary embodiment according to FIG. 3 for the method 100 to be performed in several stages.

The input dataset 36 is input into the system 30, in particular into the first system part 32, into an input device 37 of the system 30. The input device 37 can, for example, comprise a data interface, with which, for example, data can be retrieved on-line or input on-line, for example on a web-based form. It can also have a man-machine interface, for example in the form of a keyboard, a mouse and/or a touchscreen or the like.

The first system part 32 filters one or more of the comparative datasets 26 by using the input dataset 36. In the example illustrated in FIG. 3 this results in three different comparative datasets 26.

The second system part 33 makes a final selection within the pre-filtered comparative datasets 26 and supplies a resultant dataset 38, which thus corresponds to one of the pre-filtered comparative datasets 26 in this exemplary embodiment.

The third system part 34 forms a quality assurance stage. By using criteria that are as far as possible independent of the filtering or selection method of the system parts 32, 33, the third system part 34 carries out a final check on the plausibility of the resultant dataset 38. For example, the third system part 34 can be configured to check whether absolute exclusion criteria specified in the input dataset 36 are actually met by the resultant dataset 38. For example, when the input dataset 36 relates to a wall aperture and when a fire safety protective element is to be determined, a wall thickness of the pierced wall can be specified therein. Then, the fire safety protective element corresponding to the resultant dataset 38 should also actually be certified for this wall thickness. In the case of a fire safety sealing paste for filling a gap, a check can also be made, for example, as to whether the fire safety sealing paste is also actually certified for dimensions of a gap that is to be sealed that are specified in the input dataset 36.

If this quality assurance is positive, for example an identifier 42 of the protective element 12 corresponding to the resultant dataset 38 is output on an output device 40. The output device 40 can comprise an image output unit, for example a monitor, a display unit of a computer, for example of a tablet or smartphone, or the like. The output device 40 can alternatively or additionally also comprise a data interface for transmitting the resultant dataset 38 or a part of the same to a further computer. The further computer can be and/or comprise, for example, a planning system for construction planning. The further computer can also be and/or comprise a construction management system and/or form part of such a construction management system. The construction management system can be configured, for example, to order a sufficient quantity of protective elements 12 of the type corresponding to the identifier 42, to supply them to a building site on which the construction component 10 is set up, and/or to use, in particular install, them there in an automated fashion, for example with the aid of a suitable construction robot.

In general, it is conceivable that the system 30 is also designed in only one piece. Alternatively, it can also be designed in two parts or more than three parts. Accordingly, the method 100 can alternatively be designed with one step, two steps or more than three steps.

It is also conceivable that the system 30 is designed as a recommendation system and/or the method 100 is designed as a recommendation method. For example, for legal reasons it may be required that a final selection of a protective element must not be made purely mechanically. For example, provision can then be made for the results of the system 30 merely to form a proposal, which a human expert, in particular from the field of the relevant protective element type, finally checks. For example, the third system part 34 can be replaced by the human expert for this purpose.

FIG. 4 shows details relating to an exemplary embodiment of the system parts 32, 33 and the corresponding steps of the method 100 (see FIG. 3).

In this exemplary embodiment, the first system part 32 has a multiplicity of mapping matrices 44 for a 1:n assignment of property values of different properties.

One example of such a mapping matrix 44 for property values relating to fire protection elements for apertures is illustrated in FIG. 5.

One of the property values A, B, C, D, E, F, G, H, I, J, K, L or M of the input dataset 36, listed row by row (see FIG. 4), is assigned one or more of the property values A, B, C, D, E, F, G, H, I, J, K, L, M of comparative datasets 26, listed column by column (see FIG. 4), depending on the marked fields. If the property relates, for example, to a material type of a substrate, the property values A, B, C, D, E, F, G, H, I, J, K, L, M can correspond, for example, to “concrete”, “sheetrock”, “wood”, “particle board”, “metal-clad concrete”, and so on.

For example, apart from the identical property value C, the property values I and M are also assigned to the property value C. Here, a 1:3 assignment thus results.

In addition to the identical property value A, B is also assigned to the property value A. Here, a 1:2 assignment thus results.

An alternative exemplary embodiment of a mapping matrix 44 is illustrated in FIG. 6. This mapping matrix 44 corresponds largely to the previously described mapping matrix 44. One peculiarity of this mapping matrix 44 is, however, that stepped levels of assignment, illustrated in FIG. 6 by different levels of filling of the individual fields, are also taken into account therein. The levels of assignment can, for example, correspond to levels of similarity. They can also correspond to proportions in which the various property values, here material types, are alternatively to be taken into account.

As further illustrated schematically in FIG. 4, the first system part 32 is configured to assign further alternative values to the relevant property values for each property which can be isolated from the input dataset 36. From the comparative datasets 26, the first system part 32 then filters out those comparative datasets 26 which, for each of the properties that can be isolated, each have either a property value coinciding with the respective associated property value of the input dataset 36 or one of the alternative values.

For the further reduction of the quantity of pre-selected comparative datasets 26, the first system part 32 can be configured to perform a hierarchical cluster analysis, for example on the basis of a Gower distance metric, among the comparative datasets 26 that are found. As a result, the first system part 32 can also be configured to select specific clusters and elements determined by these. For example, the first system part can be configured to select the three clusters and their central elements of which the central elements come closest to the input dataset 36 with respect to the Gower distance metric.

Thus, for example, three comparative datasets 26 can result as an intermediate result and serve as input data for the second system part 33.

The second system part 33 in this exemplary embodiment has an image processing unit 46. The image processing unit 46 has a machine learning system 48 in the form of a multi-stage neural network. The machine learning system 48 is trained to segment the image data 20 (see FIGS. 2a, 2b and 2c). For example, it can be configured to distinguish straight lines versus curves, to detect and/or classify angles and/or to identify further elements, for example pipelines, supports, building parts or the like, that are typical of the application situations 14 (FIG. 1).

The second system part 33 is configured to use the image processing unit 46 to classify the image data 20 of the input dataset 36 and the image data 20 of the comparative datasets 26 identified as an intermediate result. That comparative dataset 26 or those comparative datasets 26 which, according to this classification of their image data 20, have the greatest similarity, for example once more determined by using a Gower distance metric, then form the resultant dataset 38 or the resultant datasets 38.

FIG. 7 illustrates a further example of the first and the second system part 32, 33 and the corresponding partial steps of the method 100 (see FIG. 3).

The second system part 33 can correspond to the second system part 33 described in conjunction with FIG. 4.

In this exemplary embodiment, once more image data 20 (see FIGS. 2a to 2c) of the input dataset 36 and of comparative datasets 26 are evaluated by the second system part 33. The data extracted from the image data 20 forms further, at least normal-scaled properties of the input dataset 36 or of the comparative datasets 26.

The first system part 32 of this embodiment has a further machine learning system 48 which, for example, likewise comprises a multilayer neural network. The machine learning system 48 is trained, for example by means of back-propagation and for example by using expert estimations, to assign to an input dataset 36 a most similar of the comparative datasets 26 or the most similar of the comparative application situations 27 and to output the corresponding comparative dataset 26 and/or its identifier.

The input dataset 36 is thus firstly analyzed with respect to its image data 20. The additional, at least nominal-scaled properties obtained in this way, together with the remaining, at least nominal-scaled properties of the input dataset 36, are fed to the first system part 32. The latter, in particular its machine learning system 48, determines the most similar of the comparative datasets 26 or of the associated comparative application situations 27 as a resultant dataset 38 and outputs the latter on the output device 40.

As an alternative to the output on the output device 40 or additionally thereto, it is also conceivable for final quality assurance to take place, for example with the aid of a third system part 34 (see FIG. 3).

### LIST OF DESIGNATIONS

10 Construction component
12 Protective element
14 Application situation
16 Room
20 Image data
22 Nominal-scaled data
24 Text data
25 Database
26 Comparative dataset
27 Comparative application situation
28 Resultant dataset
30 System
32 First system part
33 Second system part
34 Third system part
36 Input dataset
37 Input device
38 Resultant dataset
40 Output device
42 Identifier
44 Mapping matrix
48 Machine learning system
100 Method
A, B, C, D, E, F, G, H, I, J, K, L, M Property value

1. A system for determining a protective element of a protective element type for use in an application situation which relates to a construction component, the system comprising:
an input device,
an output device, and
a database,
wherein the database comprises a multiplicity of comparative datasets which comprise data relating to each comparative application situation, wherein the system is configured to receive via the input device an input dataset which comprises data relating to the application situation and, depending on the input dataset, to output via the output device at least one of the comparative datasets, a part of at least one of the comparative datasets, a reference to at least one of the comparative datasets and/or at least one identifier of a protective element of the protective element type.

2. The system as claimed in claim 1, wherein the database comprises at least one respective identifier of an associated protective element of the protective element type for at least one of the comparative datasets.

3. The system as claimed in claim 1, wherein the input dataset and/or at least one of the comparative datasets comprises image data.

4. The system as claimed in claim 1, wherein the input dataset and/or at least one of the comparative datasets comprises nominal-scaled data.

5. The system as claimed in claim 1, wherein the input dataset and/or at least one of the comparative datasets comprises text data.

6. The system as claimed in claim 1, wherein the system is configured to determine a subset of the comparative datasets as a function of the input dataset.

7. The system as claimed in claim 1, wherein the system has at least one mapping matrix for the 1:n assignment of property values of an application situation.

8. The system as claimed in claim 1, wherein the system has a machine learning system.

9. The system as claimed in claim 1, wherein when a limiting value of a distance between the input dataset representing the application situation and one or more of the comparative datasets is exceeded, the system is configured to output no comparative dataset, no reference to at least one of the comparative datasets and no identifier.

10. The system as claimed in claim 1, wherein the protective element type relates to fire protection elements, insulating elements, acoustic protection elements and/or moisture protection elements.

11. A method for determining a protective element of a protective element type for use in an application situation which relates to a construction component, the method comprising:
comparing, by using a system as claimed in claim 1, an input dataset which comprises data relating to the application situation with a multiplicity of comparative datasets which each comprise comparative application situations and at least one respective associated protective element of the protective element type, and
wherein, as a result of the comparison, at least one of the comparative datasets, a part of at least one of the comparative datasets, a reference to at least one of the comparative datasets and/or an identifier of a protective element of the protective element type is determined.
